(19) United States
(12) Patent Application Publication
(10) Pub. No.: US 2026/0147978 A1
(43) Pub. Date: May 28, 2026

(54) SYSTEMS AND METHODS FOR MACHINE LEARNING ASSISTED GENERATION OF REAL-TIME CONTENT ELEMENTS

(71) Applicant: IVM IP, LLC, Farmington Hills, MI (US)

(72) Inventors: Jered Heinrich, Farmington Hills, MI (US); Dennis Michael Sawyers, Farmington Hills, MI (US)

(73) Assignee: IVM IP, LLC, Farmington Hills, MI (US)

(21) Appl. No.: 18/960,671

(22) Filed: Nov. 26, 2024

(51) Int. Cl. G06F 40/166; G06F 40/103; G06T 11/60

(52) U.S. Cl. CPC G06F 40/166; G06F 40/103; G06T 11/60; G06T 2200/24

(57) ABSTRACT

Systems and methods include for generating real-time content elements using machine learning are described. A content data object is received, from a third party, and the content data object is stored a database. A validated content data object is generated by applying a filter to the content data object. The filter can remove content that is not applicable to various content generations rules, formatting rules, output types, and/or display platforms. A prompt based on the validated content data object is generated including a content generation rule and communicated to a large language model (LLM). The prompt may include content from the third party, an instruction to generate a package of real-time content elements, an output formatting rule, and a content generation rule. The LLM provides a package of real-time content elements based on the prompt that can be delivered to a display device or platform. A user interface may be generated where a user can edit the text, request the content in different styles, formats, etc., and export the generated content to the display device or platform. Rules may be stored and applied automatically to new data received from a feed.

### BACKGROUND

The present disclosure generally relates to a user generating real-time content elements with the assistance of a content drafter having machine learning capabilities imbued therein. Human writers may create content for use in the production of real-time content broadcasts. Drafting tools exist which may assist in the generation of content. There is a need for these content generation tools to be interactive allowing users to quickly adjust the writing style, the formatting, and the content selection and improve the process of generating real-time content elements by storing content generation rules so that they can automatically be applied to real-time content and delivered to a display device or platform.

### SUMMARY

An example embodiment relates to a system of one or more computers which may be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by a data processing apparatus, cause the apparatus to perform the actions.

In one general aspect, a method may include receiving, from a third party, via a network, by a processor, a content data object, and storing the content data object in a database. The method may also include generating, by the processor, a validated content data object by applying a pre-stored filter. The method may furthermore include generating, based on the validated content data object, a prompt, where the prompt includes content from the third party, an instruction to generate a package of real-time content elements, an output formatting rule, and a content generation rule. The method may, in addition, include generating, by an LLM, based on the prompt, the package of real-time content elements. The method may moreover include storing, by the processor, the package of real-time content elements in the database.

Other embodiments of this aspect include corresponding computer systems, apparatus, and computer programs recorded on one or more computer storage devices, each configured to perform the actions of the methods.

Implementations may include one or more of the following features. The method may include generating, by the processor, an interface based on the package of real-time content elements. The method may also include receiving, via the interface, an input from a user affecting the content of the package of real-time content elements. The method may further include generating an updated prompt based on the prompt and the input from the user. The method may also include receiving, from the LLM, an updated package of real-time content elements. The method may further include updating the interface based on the updated package of real-time content elements. The method may also include storing the user input in the database as a second rule, where the second rule is one of a content generation rule and a content formatting rule. The method may also include receiving, via the interface, a second input affecting the content of the updated package of real-time content elements. The method may further include generating a second updated prompt based on the updated prompt, the second input from the user, and the second rule.

Implementations of the described techniques may include hardware, a method or process, or a computer tangible medium.

An embodiment of the present disclosure relates to a method for generating media content consistent with a specific style and form, the method includes generating, by one or more processors, a validated content data object by applying a filter to a content data object from a third party. The validated content data object includes content from the third party applicable to a content generation rule. The method also includes generating, by the one or more processors and based on the validated content data object, a prompt. The prompt includes the content from the third party, an instruction to generate a package of real-time content elements, and the content generation rule. The method also includes generating, by an LLM and based on the prompt, the package of real-time content elements. The package of real-time content elements include modified content of the content from the third party modified according to the content generation rule. The method also includes communicating the package of real-time content elements to a display device.

In some embodiments, the method also includes generating, by the one or more processors, a user interface based on the package of real-time content elements. The user interface includes a content editing area, wherein the content editing area displays the modified content, and the user interface allows a user to make edits to the modified content. The method also includes generating an updated prompt based on the edits. The method also includes generating, by the LLM and based on the updated prompt, an updated package of real-time content elements. The method also includes updating the user interface based on the updated package of real-time content elements.

In some embodiments, the method also includes generating, in the user interface, an interface element that indicates an attribute for the package of real-time content elements. The method also includes receiving an updated attribute based on a user interaction with the interface element, wherein generating the updated prompt is based on the updated attribute.

In some embodiments, the method also includes generating a second content generation rule based on the edits.

In some embodiments, the method also includes the prompt also includes a formatting rule. The formatting rule includes at least one of a minimum word length, a minimum character length, a maximum word length, or a maximum character length.

In some embodiments, generating the validated content data object includes determining a portion of the content data object is applicable to the content generation rule, applying a tag associated with the content generation rule to the portion of the content data object, and generating the validated content data object based on the content data object and the tag.

In some embodiments, generating the validated content data object also includes generating style appropriateness scores by applying, to the content data object, an appropriateness filter related to an attribute of the content generation rule. The style appropriateness scores indicating a confidence level that respective portions of the content data object are suitable for application of the attribute. Generating the validated content data object also includes applying the tag to the respective portions of the content data object in response to an style appropriateness score of the style appropriateness scores being above a threshold.

In some embodiments, the attribute of the content generation rule includes at least one of a humor attribute, a solemnity attribute, a gravitas attribute, an empathy attribute, an irony attribute, a sarcasm attribute, a sensationalism attribute, a readability attribute, a technicality attribute, a jargon amount attribute, a formality attribute, an emotional tone attribute, a regional attribute, a demographic attribute, a liberalness attribute, conservativeness attribute, or a political voice attribute.

In some embodiments, the filter determines a portion of the content data object that includes at least one of mature content, violent content, sensitive group content, advertising content, irrelevant content, or malicious content.

In some embodiments, the package of real-time content elements includes at least one of a headline, a lower third chyron, a web article, a news ticker, a social media post, a blog post, over-the-shoulder graphics, full-screen graphics, sub graphics, transitions scripts and/or anchor scripts.

In some embodiments, the content data object is received via a text feed.

An embodiment of the present disclosure relates to a system for generating media content consistent with a specific style and form. The system includes one or more memory devices having instructions stored thereon that, when executed by one or more processors, cause the one or more processors to perform operations. The operations include generating a validated content data object by applying a filter to a content data object from a third party. The validated content data object comprises content from the third party applicable to a content generation rule. The operations also include generating, based on the validated content data object, a prompt. The prompt including the content from the third party, an instruction to generate a package of real-time content elements, and the content generation rule. The operations also include obtaining, by communicating the prompt to an LLM, the package of real-time content elements comprising modified content of the content from the third party modified according to the content generation rule. The operations also include communicating the package of real-time content elements to a display device.

In some embodiments, the operations also include generating a user interface based on the package of real-time content elements. The user interface includes a content editing area, wherein the content editing area displays the modified content and allows a user to make edits to the modified content and an interface element that indicates a tone for the package of real-time content elements. The operations also include generating an updated prompt based on the edits and an updated tone. The updated tone is based on a user interaction with the interface element. The operations also include obtaining, by communicating the updated prompt to the LLM, an updated package of real-time content elements. The operations also include updating the user interface based on the updated package of real-time content elements.

In some embodiments, the operations also include generating a second content generation rule based on the edits.

In some embodiments, the prompt also includes a formatting rule. The formatting rule includes at least one of an alignment, a font style, a maximum word length, or a maximum character length.

In some embodiments, generating the validated content data object includes generating style appropriateness scores by applying, to the content data object, an appropriateness filter related to an attribute of the content generation rule. The style appropriateness scores indicating a confidence level that respective portions of the content data object are suitable for application of the attribute. Generating the validated content data object also includes applying a tag to the respective portions of the content data object in response to an style appropriateness score the style appropriateness scores being above a threshold. Generating the validated content data object also includes generating the validated content data object based on the content data object and the tag.

In some embodiments, the filter determines a portion of the content data object that comprises at least one of mature content, violent content, sensitive group content, advertising content, irrelevant content, or malicious content.

In some embodiments, the package of real-time content elements includes at least one of a headline, a lower third chyron, a web article, a news ticker, a social media post, a blog post, over-the-shoulder graphics, full-screen graphics, sub graphics, transitions scripts and/or anchor scripts.

In some embodiments, the content data object is received via a text feed.

An embodiment of the present disclosure relates to a system for generating media content consistent with a specific style and form. The system includes one or more memory devices having instructions stored thereon that, when executed by one or more processors, cause the one or more processors to perform operations. The operations include determining content from a third party that is suitable for application of a content generation rule. The operations also include generating, a prompt including the determined content from the third party, an instruction to generate a package of real-time content elements, and the content generation rule. The operations also include obtaining, by communicating the prompt to an LLM, the package of real-time content elements including modified content of the content from the third party modified according to the content generation rule. The operations also include generating a user interface based on the package of real-time content elements. The user interface includes a content editing area, wherein the content editing area displays the modified content and allows a user to make edits to the modified content, and an interface element that indicates a tone for the package of real-time content elements. The operations also include generating an updated prompt based on the edits and an updated tone, wherein the updated tone is based on a user interaction with the interface element. The operations also include obtaining, by communicating the updated prompt to the LLM, an updated package of real-time content elements. The package of real-time content elements includes at least one of a headline, a lower third chyron, a web article, a news ticker, a social media post, a blog post, over-the-shoulder graphics, full-screen graphics, sub graphics, transitions scripts and/or anchor scripts.

This summary is illustrative only and should not be regarded as limiting. The various embodiments described herein may be combined in whole or in part with other described embodiments, and all such combinations are intended to be within the scope of the present disclosure.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a computing system suitable for use as a client device according to some embodiments;

FIG. 2 is a block diagram of a machine learning assisted content generation system according to some embodiments;

FIG. 3A is another block diagram of a machine learning assisted content generation system according to some embodiments;

FIG. 3B depicts illustrative examples of various user interface elements according to some embodiments;

FIG. 4 is a swimlane diagram illustrating operations performed by the client, a large language model, and a user of the content generation system to generate content according to some embodiments;

FIG. 5 is a flow diagram for generating content according to some embodiments;

FIG. 6 is a flow diagram for indicating content suitable for application of an attribute of a content generation rule according to some embodiments;

FIG. 7 is a flow diagram for generating a formatting rule or a content generation rule according to some embodiments.

### DETAILED DESCRIPTION

Systems and methods are disclosed related to machine learning assisted generation of real-time content elements. Content, for example, press releases, journalist notes, interviews, etc., from third party subscription services is received. The content may be screened using filters that determine the appropriateness of the content for certain platforms, formats, writing styles, etc. The validated content may be presented in a user interface designed to generate real-time content for media sources. The system may generate a news article for a webpage, a headline, an anchor script for televised news, a chyron related to the content, a television news ticker, a social media post, an over shoulder graphic, a transition, or any other content designed for consumption on a media platform.

Various methodologies may be used to validate content for platforms, formats, and/or writing styles. Filters may generate a binary indication of whether the content is appropriate and can be validated for a particular platform, format, and/or style. In some embodiments, the filters generate scores related to the appropriateness of the content for a particular platform, format, and/or style. The scores may be compared to a threshold to determine if the content can be used for the platform, if the format can be applied to the content, and/or if a writing style can be applied to the content. In some embodiments, the formatting and/or writing style determined to be most appropriate (e.g., highest score) are applied to the content. Alternatively, a number of highest scoring formatting rules and/or writing styles may be applied to the content. Real-time content may be generated for the most appropriate (e.g., highest scoring) platform or platforms as well. In some embodiments, a combination of a threshold and ranking may be used to determine the appropriate platforms, formats, and/or styles. For example, real-time content may be generated for the three highest scoring platforms if the scores exceed at least a minimum threshold. Similarly, real-time content may be generated using the three highest scoring formatting rules and/or writing styles if the scores exceed at least a minimum threshold.

Content validated for use with various formatting and/or content generation rules may be delivered to a large language model (LLM) in a prompt. The prompt can include the formatting rules, content generation rules, validated content, and/or example output. The content sent to the LLM and received from the LLM may be displayed in the user interface for comparison and potential editing. Appropriateness filters used to validate and screen content may limit the number of times content is generated in an inappropriate manner, limiting the computational burden on the LLM and the overall energy expenditure in creating the content. The user interface can also include interface elements that relate to different aspects of the content generation that is included in the formatting and/or content generations rules of the prompt. The user interface may include selection elements to select the type of output and/or the writing style. The user interface may include slider bars or other elements that indicate a range to modify aspects of the writing such as word length, character length, humor, readability, reading level, emotional tone, target demographic, and/or other aspects as described herein.

The content can be adjusted or modified using the interface elements and/or directly modifying the input or output content prior to being sent to the LLM. After finalization content may be delivered to the device or platform that will deliver the content to the viewer. In some embodiments, the rules (e.g., content generation rules, formatting rules, filtering rules) can be stored and used to automatically modify content received in real-time. Economic and energy expenditures may both be reduced by prefiltering content and automatically applying the rules to generate real-time content. In addition, news can be received in a specific style and on a specific platform as it is occurring.

Before turning to the figures, which illustrate some embodiments in detail, it should be understood that the present disclosure is not limited to the details or methodology set forth in the description or illustrated in the figures. It should also be understood that the terminology used herein is for the purpose of description only and should not be regarded as limiting.

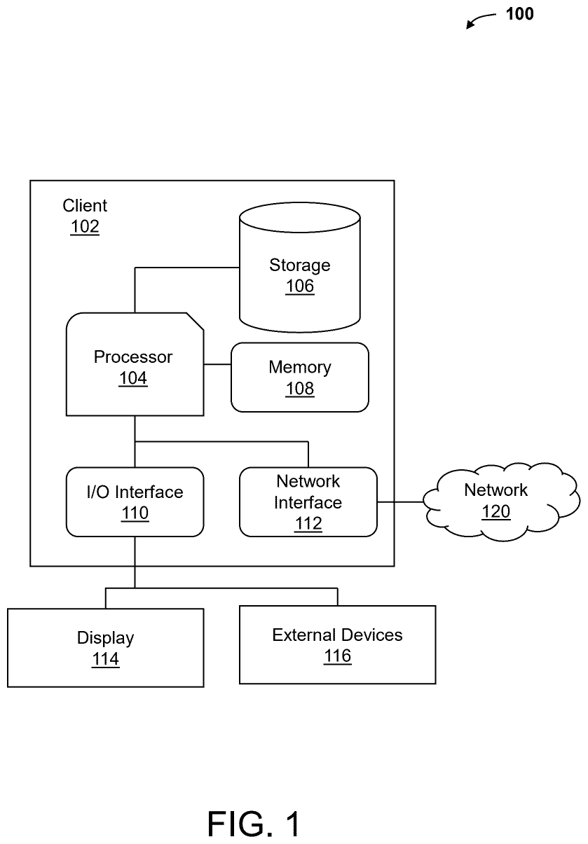

FIG. 1 is a block diagram illustrating an embodiment of a client device 102. The client device may be connected to a network 120 to interact with other devices of a machine learning assisted content delivery system 100 as will be described in more detail herein. The client device 102 may be utilized by users as a portal to interact with a broader network of computers on which the systems and methods described herein are operating. The client device 102 may be a number of computing devices that are communicably linked to a network.

The client device 102 may perform the coordination of the operations of the broader machine learning assisted content delivery system 100. In some embodiments, the client device 102 is a single computer (e.g., a desktop computer) that provides a display for a user interface and network connectivity to the broader network of computers. In some embodiments, the client device 102 may be implemented in a cloud architecture and a display device may be used to communicate with the client device 102.

The client device 102 may include one or more processors 104. The processors may be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors may be configured in various computer architectures, such as graphics processing units (GPUs), distributed computing architectures, cloud server architectures, client-server architectures, or various combinations thereof. One or more first processors can be implemented by a first device, such as a desktop computer, and one or more second processors can be implemented by a second device, such as a server or other device that is communicatively coupled with the first device and may have greater processor and/or memory resources (e.g., sufficient resources to communicated with an LLM, send, store, or process data for an LLM, and/or serve a web application).

The client device 102 may include one or more memory devices 108. The memories may include one or more devices (e.g., memory units, memory devices, storage devices, etc.) for storing data and/or computer code for completing and/or facilitating the various processes described in the present disclosure. The memories may include random access memory (RAM), read-only memory (ROM), hard drive storage, temporary storage, non-volatile memory, flash memory, optical memory, or any other suitable memory for storing software objects and/or computer instructions. The memories may include database components, object code components, script components, or any other type of information structure for supporting the various activities and information structures described in the present disclosure. The memories may be communicably connected to the processors and can include computer code for executing (e.g., by the processors) one or more processes described herein.

The client device 102 may include storage 106. Storage 106 may include one or more devices for longer term storage of data related content generation (e.g., rules, writing samples, information about previous user interface sessions, etc.). The storage 106 may include hard drive storage, temporary storage, non-volatile memory, flash memory, or any other suitable storage for storing data related to previous sessions, content samples, templates, preferences, rules, etc. In some embodiments, the storage 106 may be network storage and the client 102 may communicate (e.g., send, transmit, etc.) data to the storage 106 to be saved. For example, data stored in working memory may be sent to the storage 106 at the end of a working session.

The network interface 112 may be used to communicate with devices on the network 120. The network interface 112 may utilize a wired and/or a wireless connection. A wired connection may be an ethernet connection, a coaxial connection, a fiber optic connection, or any suitable wired network connection. A wireless connection may be a wireless local area network (WLAN), a wireless personal area network (WPAN), a wireless mesh network (MANET), global system for mobile communications (GSM), LTE/5G cellular networks, or any suitable wireless network. Network 120 may include several networks (wired, wireless, or any combination thereof) with routing hardware to deliver the information.

In some embodiments, the client device 102 includes an input-output (I/O) interface 110 to connect a number of peripheral devices (e.g., a display 114 and/or external devices 116). The display 114 may be a number of monitors, or any appropriate device for displaying a user interface to a user. The display may include light emitting diodes (LEDs), organic LEDs (OLED), a cathode ray tube (CRT), a liquid crystal display (LCD), an in-plane switching panel (IPS), a holographic display, or any appropriate manner of displaying images rendered by the processor 104 to the user.

In some embodiments, the external devices 116 may be one or more peripheral devices which may connect with the client device 102 and increase its functionality. For example, the external devices 116 may comprise a keyboard, a mouse, an external storage, a touch input device, a stylus input device, a voice input device, or any other device that may expand the capabilities of the client device 102.

In some embodiments, the network 120 may include a connection of computing devices exchanging data between one another (e.g., switches, routers, computers, etc.). The network 120 may be used to communicate information between different devices in the machine learning assisted content delivery system 100. The network 120 may be the internet or any local intranet. The client 102 may connect to the network 120 via the network interface 112.

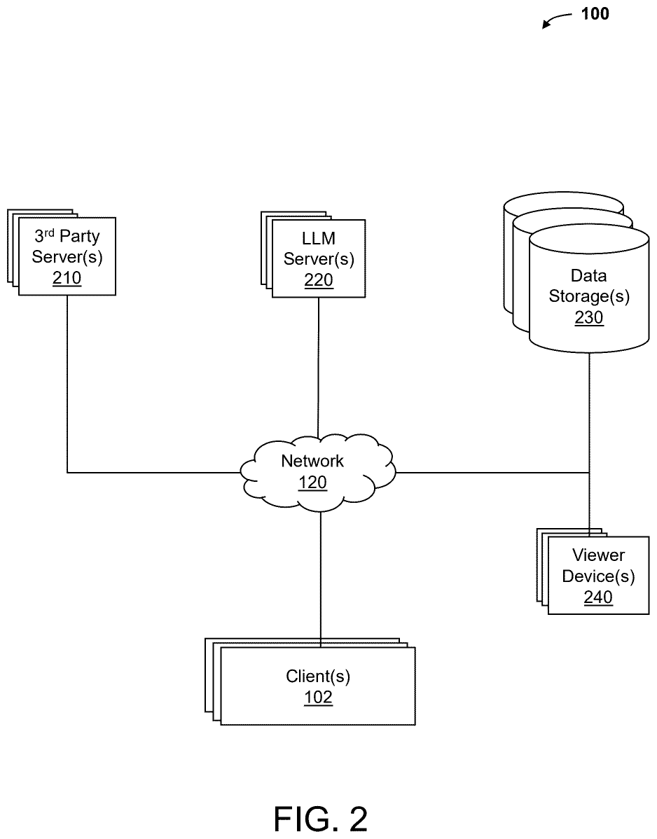

With reference to FIG. 2 the machine learning assisted content delivery system 100 is shown to include a network of interconnected devices on which the systems and methods described herein may operate according to some embodiments. The machine learning assisted content delivery system 100 may include the client device 102 and the network 120 as described above. The machine learning assisted content delivery system 100 may also include third party servers 210, large language models (LLMs) 220, data storages 230, and viewer devices 240. The network 120 may provide communication between the various devices of the machine learning assisted content delivery system 100 including client 102, third party servers 210, large language models (LLMs) 220, data storages 230, and viewer devices 240.

In some embodiments, the machine learning assisted content delivery system 100 includes one or more third-party servers 210 (e.g., from associated press). A third-party server 210 may be one or more servers associated with one or more third parties. The third-party server 210 may be interconnected and may communicate via the network 120. The third-party server 210 may provide a live content feed which may push (e.g., send, communicate, etc.) updates to devices connected to the network 120 and may be configured to maintain a connection with the third-party server(s) 210. The third-party server 210 may provide an application programming interface (API) to subscribe to content and/or to request new content. The third-party server may, for example, deliver content using a really simple syndication (RSS) feed, Atom web feed, JSON web feed, or any other suitable method to distribute content. The third party server 210 may push updates of content including news articles, blog posts, podcasts, anchor scripts etc. that include, for example, headlines, lower thirds, summaries, and/or the full content in a standardized format. In some embodiments, a content data object refers to a standardized format containing content from a web feed. For example, a content data object may refer to JSON including a news article, its headline, and its summary.

In some embodiments, the machine learning assisted content delivery system 100 includes one or more large language model (LLM) servers 220. An LLM server 220 may be one or more servers associated with a single party or multiple parties with one or more servers interconnected to provide an LLM service. The LLM server 220 may have stored therein a pre-trained LLM configured to accept prompts from external parties and provide a response based on the provided prompt. The LLM server 220 may retrieve information via the network 120 in order to generate a response to the prompt.

In some embodiments, an LLM in the LLM server may be fine-tuned for a specific purpose. For example, an LLM may be fine-tuned to summarize content or develop headlines for content. Multiple LLMs may be provided by the one or more LLM servers 220 and the machine learning assisted content delivery system 100 (e.g., the client device 102) may decide which LLM to used based on the particular task to be performed. In some embodiments, the LLM server 220 may store several LLMs and may decide which LLM to use based on the prompt. The LLMs may be built on various architectures including transformer architectures, encoder-decoder architectures, long-short term memory architectures, or any other suitable LLM architecture.

In some embodiments, the machine learning assisted content delivery system 100 may also include data storage 230. The data storage 230 may be one or more computing devices communicably interconnected and may be configured to operate as a single storage or multiple storages which may provide back-ups, organization, and greater data integrity. The data storage 230 may be one or more non-transitory computer-readable mediums.

In some embodiments, the machine learning assisted content delivery system 100 may also include viewer device(s) 240. The client 102 may make available content via the network 120 which may be accessed by one or more viewer device(s) 240. The viewer device(s) 240 may obtain content originating from the client 102 and allow the viewer device 240 user to consume the content. The viewer device(s) may include a network interface to connect with the network 120 and a display to present the content to the viewer device 240 user.

The viewer device(s) 240 may include a user interface device that provides the user interface for the machine learning assisted content delivery system 100. The client 102 may provide instructions (e.g., HTML, style sheets, JavaScript) to the user interface device that define how to generate the user interface. The user interface when generated on the viewer device may allow a user to interact with client 102. For example, the user interface may provide callbacks to APIs provided by the client that allow data manipulation, content filtering, access to the LLM and/or various other services provided by the client 102.

The viewer devices(s) 240 may also include the final display device for the content generated by the machine learning assisted content delivery system 100. For example, content may be delivered from client 102, to a teleprompter for a news anchor during a live news report. Content may also be delivered from client 102 to a social media platform that is ultimately viewed on a display device such as a smart phone or tablet. The viewer devices 240 may include any display device (e.g., mobile phone, tablet, television, computer, etc.) and may also include the platform or intermediate devices that ultimately broadcast the content to display devices either synchronously (e.g., live) or asynchronously (e.g., on user demand). For example, the platform may include a social media platform or a live broadcast platform that provides ticker stories during a news cast. In some embodiments, content is delivered to the viewer device 240 (e.g., a display device) in a specific form required by the display device. For example, content may be delivered using an API provided by the viewer device 240 and the client 102 may convert the content into the required format prior to delivery.

The machine learning assisted content delivery system 100 may also include the client device 102. As described previously, the client device 102 may perform the coordination of the operations of the broader machine learning assisted content delivery system 100. For example, client device may deliver a user interface to a viewer device 240. The client device 102 may also provide an API to respond to interactions within the user interface. The client device 102 may also generate a prompt for an LLM of an LLM server 220. The client device may subscribe or obtain content (e.g., in the form of a content data object) from a third-party server 210.

The client device 102 may also generate a prompt to send (e.g., communicate, transmit) to an LLM. For example, the client device 102 may obtain a template prompt from the storage 106, include content from example content (e.g., writing samples), add the content to be modified by the LLM given a type of formatting or style, and send the content to the LLM. The client device 102 may adjust the prompts based on a user's interaction with the user interface. In some embodiments, the client device 102 may also filter content that is not suitable for certain platforms (e.g., mature, violent, etc.) or certain content generation rules. In some embodiments, the filters prevent various prompt configurations from running, thus preventing unnecessary computations by the LLM. Computations are limited by only sending prompt configurations (e.g., configured for a particular platform and/or content generation rule) that are deemed appropriate. For example, the filter may provide a binary indication of appropriateness, the filter may provide a score that exceeds a threshold, and/or the highest scoring (e.g., top three, top five, etc.) prompt configurations may be sent to the LLM.

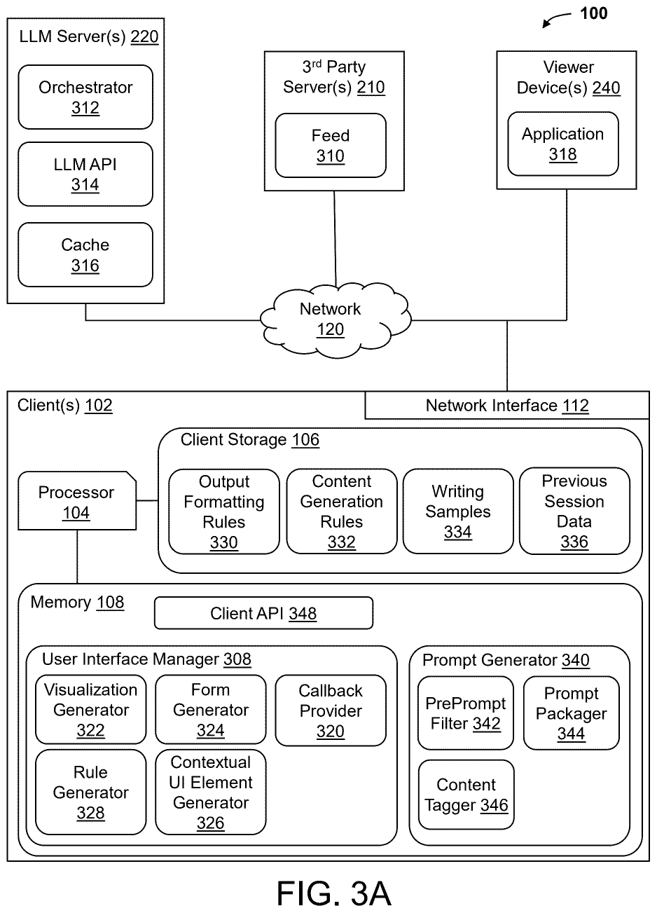

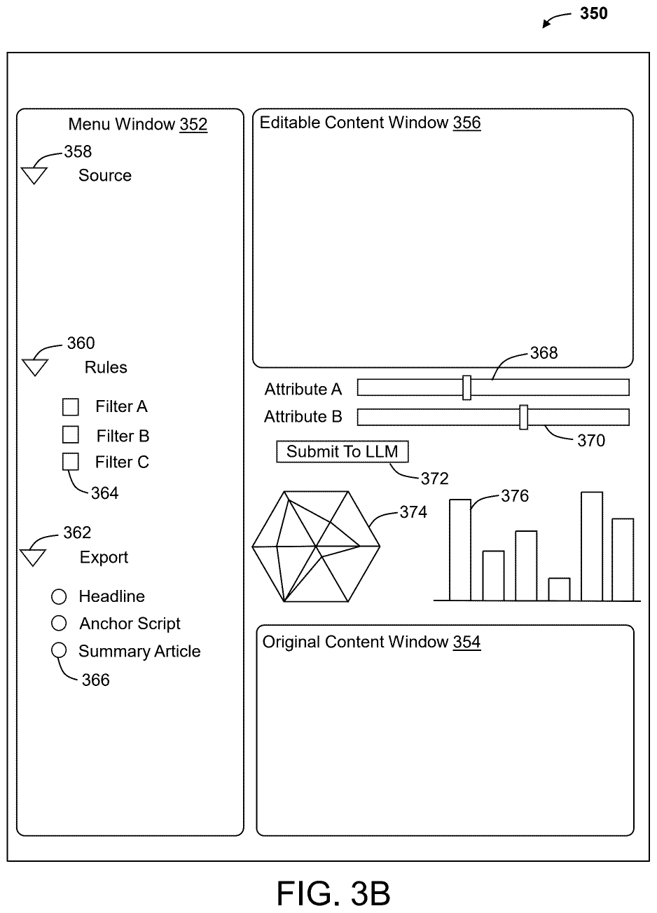

With reference to FIG. 3A, a block diagram of the machine learning assisted content delivery system 100 is shown focusing on some portions of the devices described above.

In some embodiments, an LLM server 220 includes orchestrator 312. The orchestrator 312 that may manage the multiple streams of data and ensure coordination of the functions of the LLM and the multiple data streams being input to the LLM. For example, multiple client devices 102 may all be submitting jobs (e.g., prompts, content to be processed, etc.) to the LLM server 220 or the LLM server 220 may be provided by a third party and is being by other systems at the same time. The orchestrator 312 may determine the sequence in which prompts are processed. For example, the orchestrator 312 may queue jobs based on priority, order they are entered, and/or based on the time they are required. The orchestrator 312 also coordinate the data flow through the layers of the LLM as data is being processed and/or executed by the LLM.

In some embodiments, the LLM server 220 may also include an LLM API 314 for managing communications between the LLM server 220 and outside parties. For example, the LLM API 314 may receive a prompt from a client 102.

In some embodiments, the LLM server 220 may also include a cache 316 for storing the data received by the LLM server 220 while receiving and operating on the data received from external sources.

In some embodiments, the viewer device 240 may include an application 318 which may provide an interface between the client 102 and the viewer device 240. The application 318 may receive information from the client 102 to populate the application 318 with content for the user. For example, the application may provide a user interface for the user to interact with the content and/or request modifications to the content. In some embodiments, the application may be an internet browser such as GOOGLE CHROME, MOZILLA FIREFOX, MICROSOFT EDGE, APPLE SAFARI, or any other appropriate browser. In some embodiments, the viewer devices(s) 240 may include an application for the final display device for the content generated by the machine learning assisted content delivery system 100. For example, the viewer device 240 may provide an interface (e.g., API, web-based interface, remote management tools, etc.) to which client 102 can send commands and deliver the generated content. The client 102 may convert the content into the format required by the API prior to delivery.

In some embodiments, the party server 210 includes a feed 310, which provides data in real time to the client 102. In some embodiments, the feed 310 may be an API of a third party for distributing their content. In some embodiments, the feed 310 may be a really simple syndication (RSS) feed, atom syndication feed, JavaScript Object Notation (JSON) feed, or any appropriate format for outputting live streams of information over the internet. The news feed may provide structured data (e.g., content data object) providing news articles, journalist notes, or other forms of media content to the client 102.

In some embodiments, the client 102 includes a user interface manager 308. The user interface manager 308 may provide the instructions to generate the user interface for interacting with content received from the feed 310. The user interface manager 308 may provide instructions for generating a user interface that is local to the client 102 (e.g., presented on the display 114 connected via the I/O interface 110) and/or may provide instructions for generating a user interface on a remote viewer device 240. To provide the interface, the user interface manager 308 may coordinate calling (e.g., executing, running, referencing, etc.) a callback provider 320, a visualization generator 322, a form generator 324, contextual UI element generator 326, a rule generator 328. In some embodiments, the user interface may be accessed, served, and/or interacted with in the same manner both locally and/or remotely, allowing deployment flexibility.

In some embodiments, the visualization generator 322 may provide the styles (e.g., style sheets, etc.) to present any of the visualizations that make up the user interface. The visualization generator may include instructions for the layout and positioning of the elements within the user interface. For example, the user interface may include an area to display the original data of the content data object and a modified version of the content delivery object after it has been processed by a LLM (e.g., of LLM server 220) and/or edited by a user. The visualization generator 322 may also specify the layout and position of the display areas. Visualization generator 322 may also include font sizes, colors, backgrounds, and/or anything else related to the style of the user interface. In some embodiments, the visualization generator 322 may take information intended for presentation to the user and prepare a visualization to better present the information. For example, a score related to the content (e.g., an appropriateness or suitability score of various attributes of a content generation rule) may be transformed to a bar chart or radar chart. Visualization may include a table, a bar chart, a pie chart, a line graph, a scatter plot, a heat map, an area map, a histogram, a bubble chart, a box plot, a timeline, a line spectrum, a tree map, a Gantt chart, a Venn diagram, a word cloud, a matrix, or any appropriate vehicle for visualizing data to a user.

In some embodiments, user interface manager 308 includes a form generator 324. The form generator 324 may provide instructions to produce multiple fields filled with text that may be edited by the user operating the client 102. For example, the form generator 324 may generator text boxes or forms including text generated by the LLM server 220, retrieved from the data storage 230, or manually entered by the user. Data (e.g., text) in forms provided by form generator 324 may be edited or otherwise changed by the user and used as input to functionality of the client 102. For example, text may be modified by the user and communicated to the LLM to adjust the style and/or proofread the text for errors.

In some embodiments, the contextual UI element generator 326 provides buttons, sliders, input fields, checkboxes, drop-down menus, a container, radio buttons, toggles, date pickers, labels, icons, search fields, carousels, menus, or any other appropriate component to allow a user to interact with the user interface. For example, a slider next to an editable text field may allow the user to control the tone of the text in the text field, where sliding to the left increases the political voice of the writer to the political left, while sliding to the right increases the political voice of the writer to the political right. Checkboxes may be used to select filters provided by the machine learning assisted content delivery system 100. Dropdown menus may be used to select received content to edit. And/or radio buttons may provide the user a method to select the output type of the content to generate.

User interface manager 308 may also include the rule generator 328 to allow a user to create rules for text generation in an editable text box or through the use of other user interface elements (e.g., created by contextual UI element generator 326). In some embodiments, the rules may be related to the desired formatting (e.g., font, word length, etc.), content (e.g., writing style, writing tone, etc.), and restrictions regarding when those rules should be applied to the real-time content elements desired by the user (e.g., if rules are suitable for certain content). In some embodiments, rules may be applied to the current content, stored and applied to future content that satisfies the criteria, and/or retroactively applied to content that may have already been published. In some embodiments, rules may be defined by the number of articles that a particular rule should be applied to before a user interacts with the user interface again or a date (and/or time) after which the rule will no longer be applied (e.g., to prevent stale content, quality control, etc.).

User interface manager 308 may also include the callback provider 320 to provide functionality (e.g., instructions, code, etc.) that should be performed when certain user interface elements are interacted with (e.g., a button is depressed, etc.). The callback provider 320 may provide instructions to perform certain requests (e.g., post, get, etc.) of the client API 348 when the user interacts with an element. For example, the user interface may contain a button that when depressed will cause the client 102 to send information to a LLM server 220 for processing or will cause the client 102 to store a rule.

With reference to FIG. 3B, a user interface 350 is shown with some elements of a user interface for the machine learning assisted content delivery system 100 according to some embodiments. The user interface 350 is not intended to be complete or limiting, but is used to describe various elements that user interface manager 308 may provide.

The user interface 350 may include a menu window 352. The menu window 352 may allow a user to select various options related to content generation. A source dropdown 358 may be used to select the content source. When the source dropdown 358 is expanded, options related to the source may be provided. For example, the option to select from various third-party feeds 310 or the option to select a type of content (e.g., news, sporting event, etc.) may be provided.

The user interface 350 may include an original content window 354 and an editable content window 356 to display text as described with reference to the form generator 324. For example, after a source is selected the content may be added to the original content window 354. In some embodiments, a predefined rule is automatically selected and communicated with the original content to a LLM server 220, for example, to populate the editable content window 356 with a result. In some embodiments, the user can edit the original content in the original content window 354 prior to sending the content to the LLM server 220 (e.g., an initial time or a second time).

The user interface 350 may include a radar chart 374 and/or bar chart 376 to indicate various metrics about the content. For example, a style appropriateness score of application of attributes of a rule or the political tone may be indicated in the radar chart 374 and/or bar chart 376. The charts may allow the user a quick reference to the scores of the original content and/changes made to the content. In some embodiments, the radar chart 374 and/or bar chart 376 may show the scores (e.g., metrics) both of the original content and the modified content (e.g., received from the LLM server 220).

A rules dropdown 360 may be used to select rule options as described with reference to rules generator 328. For example, rules generator may provide selection boxes 364 to filter certain content. For example, rules generator may filter content for which an attribute (e.g., humor, readability, etc.) score is less than a certain value by selecting the appropriate box. The rules dropdown 360 may be used to add additional rules related to content generation as described with reference to rules generator 328. For example, the rules dropdown 360 may include editable text fields for word length, font, etc. The user interface manager 308 may also generate a button that when depressed will save the current rule executed.

In some embodiments, user interface may have a slider bar (e.g., the slider bar 368 or 370) to change the degree of an attribute. For example, slider bars may be used to adjust political voice (e.g., conservativeness), readability, humor, or any other attribute that may have a continuum of applicable values. A user may interact with the slider bars 368 or 370 and then use the submit to LLM button 372 in order to submit a prompt with the adjusted attribute and view the results. In some embodiments, when a user interface element is interacted with it is highlighted or it otherwise indicates that it has been changed from the inputs that generated the content in editable content window 356. Depressing the submit to LLM button 372 may cause client 102 to send a prompt with a content generation rule that has the applied changes to the voice, style, etc. and new content may be received and be placed in editable content window 356.

An export dropdown 362, may allow the user to select a type of output (e.g., type of content generated) using radio box 366. For example, a headline, anchor script, summary article, social media post or any other form of media may be provided as a selectable output. The export dropdown 362 may also provide an editable field or drop down for the final destination of the content. For example, the user interface manager 308 may generate a button that when depressed will export the text (or other information) in editable content window 356 to the publishing platform (e.g., social media platform, news ticker generator, etc.). In some embodiments, the export dropdown 362 allows for export to a single destination, multiple destinations, or all destinations. For example, selection boxes may be provided instead of radio boxes or a dropdown menu configured to allow multiple selections may be provided.

Referring again to FIG. 3A, the client 102 may include a client storage 106, which may include storage for output formatting rules 330, content generation rules 332, writing samples 334, and previous session data 336. Content in client storage 106 may be used to generate the user interface (e.g., initial rules, settings, etc.) and to generate the prompt sent to the LLM (e.g., writing samples, formatting rules, etc.).

The user interface may provide a method (e.g., button, callback, etc.) to store the current rule designed by rule generator 328 in client storage 106. The rules may be saved and used for any future content provided to client 102. In some embodiments, default rules may be selected and run initially when the content is opened in the user interface. In some embodiments, the rules may be automatically applied to new content (e.g., from a particular source and/or that satisfies a filter) for a period of time without user oversight.

In some embodiments, the output formatting rules 330 (e.g., generated by the rule generator 328) relate to how the formatting of content generated should be altered to conform to the desires of the user. For example, the user may be editing media via a user interface generated by user interface manager 308 and save a rule to cause future content generated to be center-aligned. Before prompts are constructed and sent to the LLM server 220, the appropriate rules may be retrieved from the storage for output formatting rules 330. The output formatting rules 330 can also apply structure to the output of the text. For example, an output formatting rule may apply JSON schema or HTML tags to the text in order to conform to the needs of the display platform.

In some embodiments, the content generation rules 332 (e.g., generated by the rule generator 328) relate to how text generated should be altered to conform to the desires of the user. For example, the user may be editing content via a user interface generated by user interface manager 308 and save a rule to cause future content generated to be written in a manner where the viewer will consume the content in a light-hearted manner. Before prompts are constructed and sent to the LLM server 220, the appropriate rules may be retrieved from the storage for content generation rules 332.

In some embodiments, the storage 106 may include storage for content samples 334. The content samples 334 may be curated and tagged with relevant information. For example, content samples 334 may include writing samples that may be directed to specific topics, that use a certain writing style, that are particularly persuasive, or any other writing examples that would be valuable when attempting to generate real-time content elements. In some embodiment, content samples are used as examples for the LLM. Content samples may be selected by client 102 during prompt generation based on, for example, a user's interaction with the user interface (e.g., the status of a slider bar, etc.). In some embodiments, the content samples 334 may be any form of media such as graphics, pictures, text, videos, or audio-based content; the LLM servers 220 may be trained to process the form of media; and the user interface may be configured to display the type of media.

In some embodiments, the storage 106 may include storage for previous session data 336. In some embodiments, previous session data 336 may include any information collected from previous sessions of use by a user and may include user preferences, patterns of use, user sensibilities, user's writing style, user interface setup, current rule status, and other user inputs tracked during interactions with the user interface generated by user interface manager 308.

In some embodiments, the client 102 may include the client API 348 for managing communications between the client 102 and outside parties. For example, the client API 348 may send a prompt or receive a response to a prompt from the LLM API 314. In some embodiments, the viewer devices 240 may trigger client API 348 when a user interacts with the user interface (e.g., to cause a prompt to be sent to the LLM servers 220, to save a rule, etc.)

In some embodiments, the client 102 includes a prompt generator 340. The prompt generator 340 may coordinate the generation of prompts to be sent to the LLM servers 220. Prompt generator 340 may generate prompts each time content is received or on a period (e.g., minutely, hourly, daily) for all new prompts. The prompt generator 340 may validate the content using a PrePrompt filter 342, tag content or portions thereof with for application of various style attributes using a content tagger 346, and package together the parts of the prompt (e.g., content, writing samples, content generation rules, formatting rules, etc.) using a prompt packager 344.

In some embodiments, prompt generator 340 may include the PrePrompt filter 342. The PrePrompt filter 342 may parse the content received from third parties or input by the user and filter duplicates, age verify the content, apply content restrictions (i.e., maturity filter, sarcasm filter), determine attribute (e.g., humor, readability, etc.) appropriateness rating, and any other appropriate content rule application.

In some embodiments, prompt generator 340 may include the content tagger 346. The content tagger 346 may tag or otherwise indicate for portions of the content intended for processing by the LLM server 220. For example, the PrePrompt filter 342 may tag data to be processed (e.g., style changed, etc.) by the LLM and instruct the LLM to leave untagged content unmodified in the prompt. In some embodiments, the PrePrompt filter 342 may remove portions of content (e.g., untagged content) or add content from a third party, data storage 230, or client storage 106.

In some embodiments, the prompt generator 340 may include prompt packager 344. The prompt packager 344 may package the content edited by the user and processed by PrePrompt filter 342 in order to send it, via network interface 112 to the LLM server 220. The prompt packager 344 may include various prompt templates that are selected based on the content generation rules, the formatting rules, and/or any other input that may change how the content needs to be sent to the LLM servers 220. The prompt packager 344 may perform a substitution with the template and the content to create the prompt. The prompt packager may, for example, fill in the template with writing samples 334 from client storage 106, formatting rules, and content generation rules. The rules may be obtained from client storage 106 or from the current user interface session.

Non-limiting examples of formatting rules that may be applied by the machine learning assisted content delivery system 100 include rules related to an alignment, a font style, a maximum word length, a minimum word length, a maximum character length, and/or a minimum character length. Some formatting rules (e.g., alignment, font style, etc.) may not be processed by the LLM (e.g., of the LLM servers 220) and are instead added by the client 102 during export. An LLM may not always respect a word length (and/or character length) target or bounds. In some embodiments, the machine learning assisted content delivery system 100 is configured to iteratively provide prompts to the LLM to reach the length target and/or bounds. For example, the machine learning assisted content delivery system 100 may iteratively ask the LLM to increase or decrease the length of a response until a desired length is achieved.

Non-limiting examples of style or tone attributes that can be modified by content generation rules applied by the machine learning assisted content delivery system 100 include a humor attribute, a solemnity attribute, a gravitas attribute, an empathy attribute, an irony attribute, a sarcasm attribute, a sensationalism attribute, a readability attribute, a technicality attribute, a jargon amount attribute, a formality attribute, an emotional tone attribute, a regional attribute, a demographic attribute, a liberalness attribute, conservativeness attribute, or a political voice attribute. Some style or tone attributes are single dimensional attributes. For example, formality attribute may allow for more or less formality. Some style or tone attributes are multi-dimensional. For example, a political voice attribute may include an economic scale and a social scale that can be used to modify the content. Similarly a demographic attribute may have multiple scales related to different target audiences.

Non-limiting examples of filters that can be used by PrePrompt filters 342 include filters related to mature content, violent content, sensitive group content (e.g., content that may be filtered based on special consideration for a group of people), advertising content, irrelevant content, and/or malicious content. Non-limiting examples content that may be generated by the machine learning assisted content delivery system 100 include a headline, a lower third chyron, a web article, a news ticker, a social media post, a blog post, over-the-shoulder graphics, full-screen graphics, sub graphics, transitions scripts and/or anchor scripts.

FIG. 3A shows an example block diagram of the machine learning assisted content delivery system 100 according to some embodiments and should not be regarded as limiting. In some emobdiments, the machine learning assisted content delivery system 100 may include additional blocks, fewer blocks, different blocks, or differently arranged blocks than those depicted in FIG. 3A. Additionally, or alternatively, two or more of the blocks of the machine learning assisted content delivery system 100 may operate in parallel.

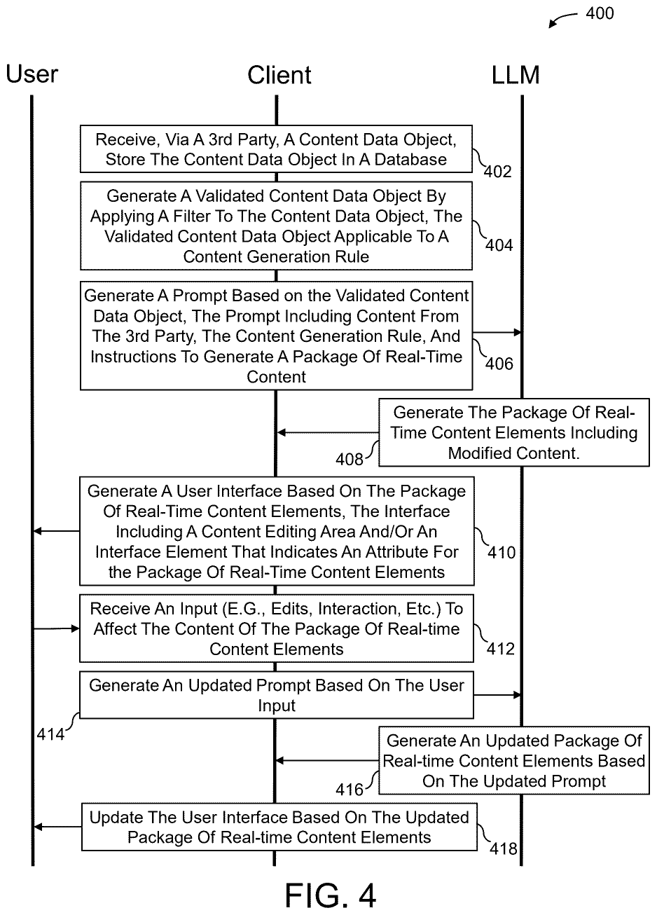

FIG. 4 is a swimlane diagram for a flow of operations 400 according to some embodiments. The flow of operations 400 may, for example, be performed by the machine learning assisted content delivery system 100 to generate real-time content with assistance from a machine learning model. In addition to the operations that make up the flow 400, the swimlane diagram also indicates the devices of the machine learning assisted content delivery system 100 that perform the operations according to some embodiments. For example, some operations of the flow 400 may be performed by the processor 104 of the client device 102, some operations may be performed by a LLM (e.g., of LLM servers 220), and some actions may be performed by a user.

In some embodiments, the flow 400 includes receiving, from a third party, a content data object and storing the content data object (e.g., in the client storage 106 or the data storage 230) for processing in an operation 402. For example, the processor 104 may access an RSS feed from one or more sources, as described above. In some implementations, the user may indicate or have already indicated a topic, timespan, subject, event, or person in order to narrow the content received from the RSS feed. In some embodiments, the one or more feeds 310 may push content to the client 102 based on predetermined criteria such as importance, virality, relatedness to specific topics, and/or any other appropriate criterion for filtering content from third parties. Content pushed to client 102 may be then processed by the flow of operations 400.

The flow 400 may also include generating, by the processor, a validated content data object by applying a filter to the content data object in operation 404. The validated content data object may be applicable to a content generation rule (e.g., appropriate for the content generation rule). For example, the processor 104 may execute commands as described by PrePrompt filter 342 to generate the validated content data object. In some embodiments, the filter may filter duplicates, age-inappropriate content, apply content restrictions (i.e., maturity filter, sarcasm filter), and any other appropriate content to prevent non-applicable content being provided to a content generation rule. In some embodiments, an appropriateness filter related to an attribute of a content generation rule may be executed to tag or otherwise indicate content that for which an attribute can be modified (e.g., applied, increased, etc.). For example, a humor appropriateness filter may generate a score related to the content that is amenable to the application of humor and tag content or portions thereof for which the score is above a threshold.

Filters may be executed by the processor 104 and/or assisted by or executed by an LLM server 220. Certain rule-based logic may be used to filter duplicates, determine age-appropriateness levels, perform content type matching etc. and may be run by the processor 104. Some filters, for example a humor appropriateness filter, may be better suited for detection by a machine learning model. In some embodiments, memory 108 may store one or more pretrained machine learning models specifically for the purpose of executing one or more appropriateness filters by the processors 104. In some embodiments, appropriateness filters may be executed by generating another prompt for the same or different (e.g., find-tuned) LLM, asking it to rate the appropriateness of a particular attribute. Using an LLM may provide the advantage of extensibility to new attributes for which no filter has been specifically defined.

Prefiltering content may provide an advantage over other systems by systematically eliminating the execution of content generation rules against content for which the rule is not applicable or not appropriate. Additionally or alternatively, the machine learning assisted content delivery system 100 can select the most appropriate content generation rule, for example, by style appropriateness scores. Economic and energy expenditures are both reduced by prefiltering content either by rule based or LLM based appropriateness filters and executing the LLM against content generation rules (and/or prompt configurations) for which the content is appropriate.

In some embodiments, the flow 400 includes generating, based on the validated content data object, a prompt, where the prompt includes content from the third party, an instruction to generate a package of real-time content elements, and a content generation rule in an operation 406. For example, processor 104 may, using prompt packager 344, package the content after it has been received from the third-party content sources and/or package archived content. Generating the prompt may include performing a content substitution against template prompts as described with reference to the prompt packager 344. The operation 406 may also include communicating (e.g., sending, transmitting, etc.) the prompt to an LLM server 220 for processing. In some embodiments, the prompt may also include a formatting rule (e.g., word count, etc.) as described previously.

In some embodiments, the prompt may include several example outputs to cause the large language model to follow the format of the examples. For example, headlines can be provided to cause the LLM to generate headline styled output. In some embodiments, formatted (e.g., JSON, HTML, etc.) content may be provided to the LLM as an example to cause the LLM to generate the output directly in the proper format to send to the display and/or the viewer device 240. Content examples may be saved and retrieved from client storage during the operation 406. Without limitation the LLM may deliver content related to generating a lower third chyron, over-the-shoulder graphics, full-screen graphics, anchor and/or transition scripts, web articles, article summaries, social media posts etc.

After the operation 406, the flow 400 may temporarily transition to the LLM for prompt processing in an operation 408. The operation 408 may include generating, by an LLM and based on the prompt, the package of real-time content elements. The real-time content elements, for example, may include raw text to be sent to the final display and/or viewer device or the real-time content elements may include all the formatting required to send directly to the final display and/or viewer device. For example, the viewer device 240 may be a web platform and the content will ultimately be displayed using an internet browser on computer, mobile phone, tablet, etc. The real-time content elements may be generated directly in HTML with appropriate tags, to indicate formatting as defined by the formatting rules. In some embodiments, non-textual content may also be provided to the LLM for processing.

The flow 400 may return to processing by the client 102 to generate a user interface based on the package of real-time elements in an operation 410. The interface may include a content editing area (e.g., text window, etc.) and interface elements that indicate an attribute for the package of real-time content elements. For example, the user interface may include a slider bar indicative of (e.g., related to) the amount of an attribute in the content and/or the increase in the amount of an attribute used to generate the content when sent to the LLM for processing. The user interface may include additional plots as part of the user interface element related to the attribute (e.g., humor, conservativeness, etc.). For example, radar plots or bar charts may be used to indicate the current amount of the attribute indicated in the content. The combination of the components of the user interface element may allow the user to view the current amount of the attribute and interact with a component to adjust the desired amount of the attribute. Without limitation several elements, components, areas, etc., that may be generated for the user interface were described with reference to FIG. 3B.

In some embodiments, a user (e.g., editor, writer, etc.) can interact with the user interface to adjust the content. The user may edit the text and/or interact with a slider bar adjusting an attribute of the content generation rule. For example, the user may adjust a humor rating of the article from 4 to 7 using a humor slider bar. The client 102 may receive the edits, interaction, etc. to affect the content of the package of real-time content elements in an operation 412. Similar to the operation 406 an updated prompt can be generated based on the user input in an operation 414. For example, the prompt may include an updated content generation rule (e.g., including a new amount of an attribute) and/or include edited text. The prompt may be communicated to the LLM servers 220. In some embodiments, any new content generation rules or formatting rules in the updated prompt may be saved (e.g., automatically or by user request).

The flow 400 may include generating, by the LLM, an updated package of real-time content elements based on the updated prompt in an operation 416. In an operation 418 the client 102 may generate an updated (e.g., update) the user interface based on the updated package of real-time content elements. For example, the new outputs from the LLM may be displayed in the user interface for adjustment or export to the final viewer device. The operations 412-418 may be repeated any number of times until the user is satisfied with the current content and the rules (e.g., content generation and formatting) are saved and/or the content is exported.

Although FIG. 4 shows operations of the flow 400, in some implementations, the flow 400 may include additional operations, fewer operations, different operations, or differently arranged operations than those depicted in FIG. 4. Additionally, or alternatively, two or more of the operations of the flow 400 may be performed in parallel.

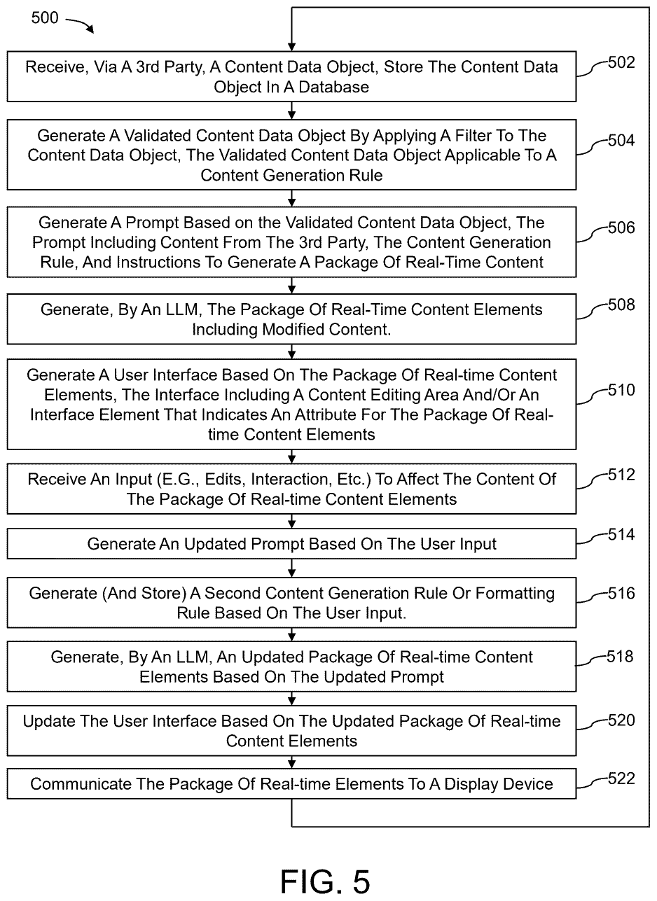

FIG. 5 is a flow diagram for a flow of operations 500 for generating real-time content with assistance from a machine learning model according to some embodiments. The flow of operations 500, may for example, be performed by the machine learning assisted content delivery system 100. In some embodiments, the operations of flow 500 may be performed by client 102.

Many of the operations of the flow 500 are similar to those of the flow 400. In some embodiments, the flow 500 includes receiving, from a third party, a content data object and storing the content data object (e.g., in the client storage 106 or the data storage 230) for processing in an operation 502 which may be similar to the operation 402. The flow 500 may also include generating, by the processor, a validated content data object by applying a filter to the content data object in an operation 504 which may be similar to the operation 404. The validated content data object may be applicable to a content generation rule. In some embodiments, the flow 500 includes generating, based on the validated content data object, a prompt, where the prompt includes content from the third party, an instruction to generate a package of real-time content elements, and a content generation rule in an operation 506 which may be similar to the operation 406.

Similar to the operation 408, an operation 508 may include generating, by an LLM and based on the prompt, the package of real-time content elements. The operation 508 may depend on the scope of the system performing the operation. For example, if the scope of the system is taken to include the LLM, the operation 508 may include generating, by an LLM and based on the prompt, the package of real-time content elements. If the scope of the system is taken to include only the client 102, the operation 508 may include receiving, from an LLM and based on the prompt, the package of real-time content elements.

In some embodiments, the flow 500 includes generating a user interface based on the package of real-time elements in an operation 510 which may be similar to the operation 410. The interface may include a content editing area (e.g., text window, etc.) and interface elements that indicate an attribute for the package of real-time content elements. The flow 500 may include receiving the edits, interaction, etc. to affect the content of the package of real-time content elements in an operation 512 which may be similar to the operation 412.

In an operation 514 (which may be similar to the operation 414), an updated prompt can be generated based on the user input in operation. The updated prompt may include an updated content generation or formatting rule. In some embodiments, the updated rules can be stored in an operation 516. The stored rules may be used to automatically run against future content (e.g., based on a filter or a user's association). For example, the updated rules may be stored in the output formatting rules 330 or the content generation rules 332 of the client storage 106 to be recalled later by the prompt generator 340 when new content is received.

Similar to the operation 416, an operation 518 may include generating, by an LLM and based on the updated prompt, an updated package of real-time content elements. The operation 518 may depend on the scope of the system performing the operation. For example, if the scope of the system is taken to include the LLM, operation the 518 may include generating, by an LLM and based on the updated prompt, the updated package of real-time content elements. If the scope of the system is taken to include only the client 102, the operation 518 may include receiving, from an LLM and based on the updated prompt, the updated package of real-time content elements.

The flow 500 may include generating an updated (e.g., updating) the user interface based on the updated package of real-time content elements in an operation 520 (which may be similar to the operation 418). For example, the new outputs from the LLM may be displayed in the user interface for adjustment or export to the final viewer device. The operations 512-520 may be repeated any number of times until the user is satisfied with the current content. After finalizing content, the flow 500 may include communicating the package of real-time elements to a display device in an operation 522. The display device (e.g., viewer device 240) may include an API that can be used in order to communicate the content and the client 102 may convert the content into the format required by the API prior to delivery. The generated content will then be available for use in the viewer device's platform (e.g., available on a web page, social media post, ticker graphic generation tool, etc.)

Although FIG. 5 shows operations of the flow 500, in some implementations, the flow 500 may include additional operations, fewer operations, different operations, or differently arranged operations than those depicted in FIG. 5. Additionally, or alternatively, two or more of the operations of the flow 500 may be performed in parallel.

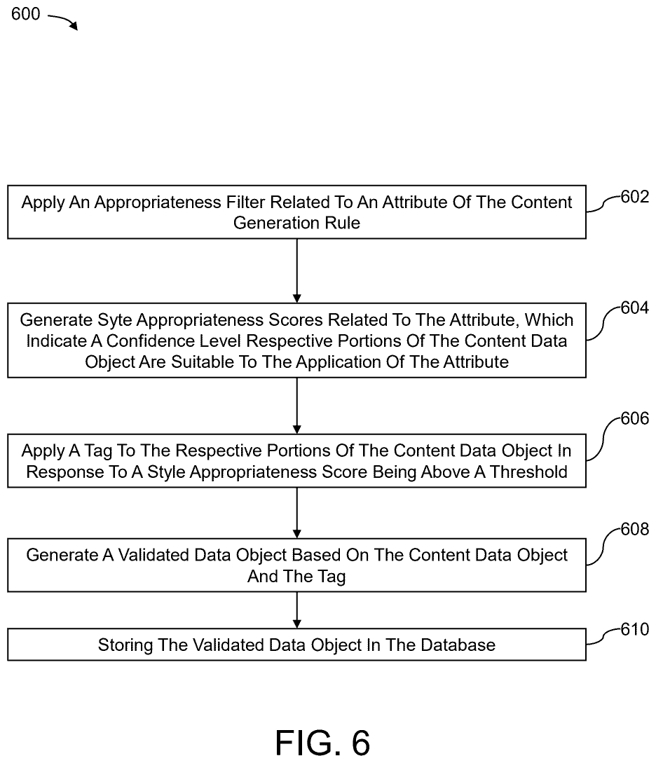

FIG. 6 is a flow diagram for a flow of operations 600 for tagging content suitable for the application of an attribute (e.g., humor, etc.) according to some embodiments. The flow of operations 600, may for example, be performed by the machine learning assisted content delivery system 100 (e.g., by client 102 using PrePrompt filter 342).

The flow 600 may include applying an appropriateness filter related to an attribute (e.g., humor, etc.) of the content generation rule in an operation 602. The appropriateness filter, for example, may generate style appropriateness scores related to the attribute in an operation 604. The style appropriateness scores, for example, may indicate a confidence level respective portions (e.g., those portions for which the score is calculated) of the contend data object are suitable to the application of the attribute. In some embodiments, the PrePrompt filter 342 may include specially trained machine learning models (e.g., classifiers, neural networks, distance metrics, etc.) that can be used to determine the style appropriateness score. For example, a sigmoid classifier may be used to calculate the probability that an attribute can be applied to a portion of the content. In some embodiments, an LLM is used (e.g., the same LLM used to generate the content) to query the style appropriateness score with an engineered prompt.

After style appropriateness scores are calculated, the flow 600 may continue by applying a tag to portions of the content data object for which the style appropriateness score is greater than a threshold in an operation 606. For example, if a sigmoid classifier is trained to determine style appropriateness scores, the threshold may be an estimated probability of greater than 0.8. Tuning may be performed on the threshold in order to determine a value for which the tradeoff between the cost of skipping potential content and the cost of applying an inappropriate or nonapplicable to content are both considered. In some embodiments, a tag may be applied to (and content generation rule executed on) the category with the highest score.

In some embodiments, the flow 600 includes generating a validated data object based on the content data object and the tag in an operation 608. The validated data object may be ready for processing by a LLM with a content generation rule related to the attribute. The flow 600 may include storing the validated data object in an operation 610. For example, validated data objects may be stored to be later processed by the LLM with results being either sent the viewer device and/or the user interface. In some embodiments, the validated data object will be stored in the client storage 106 or the data storage 230 and used as a source in the user interface so that a user can manipulate the content and/or generate new content generation rules using the content. In some embodiments, the validated data object will be stored in the client storage 106 or the data storage 230 and automatically processed by the machine learning assisted content delivery system 100.

Although FIG. 6 shows operations of flow 600, in some implementations, flow 600 may include additional operations, fewer operations, different operations, or differently arranged operations than those depicted in FIG. 6. Additionally, or alternatively, two or more of the operations of flow 600 may be performed in parallel.

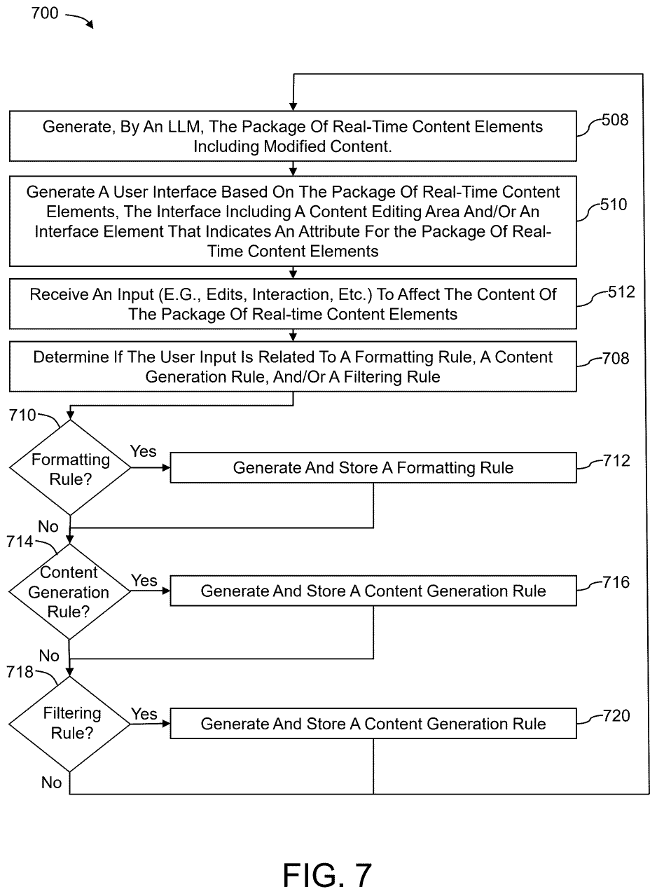

FIG. 7 is a flow diagram for a flow of operations 700 for storing a new content generation rule, filtering rule, and/or formatting rule according to some embodiments. In some embodiments, one or more operations of the flow 700 may be performed by the processor 104 of the client 102. The flow 700 may begin by receiving the edits, interaction, etc. to affect the content of the package of real-time content elements in the operation 512. For example, the operations 508 and 510 may have been performed to generate a package of real-time elements and generate a user interface based on the package real-time elements, respectively. The user may have just completed an interaction with the user interface.

The flow 700 may include determining if the user input is related to a formatting rule, a content generation rule, and/or a filtering rule. In some embodiments, the user interface may have the different rule classes separated into different areas and the determination can be made by the area that is open (e.g., which dropdown menu is expanded or which tab is in focus). In some embodiments, a rule class may be linked to each element or component thereof to determine the rule class that was modified. The flow 700 may then pass through a series of flow control operations that determine if a rule should be generated and saved. An operation 710 may control flow to generating and storing a formatting rule in an operation 712 if it is determined that the input was related to a formatting rule or continuing to an operation 714 if the input was not related to a formatting rule. The operation 714 may control flow to generating and storing a content generation rule in an operation 716 if it is determined that the input was related to a content generation rule or continuing to an operation 718 if the input was not related to a content generation rule. The operation 718 may control flow to generating and storing a filtering rule in an operation 720 if it is determined that the input was related to a filtering rule. The flow 700 may be repeated as new interactions are detected.

Although FIG. 7 shows operations of the flow 700, in some implementations, the flow 700 may include additional operations, fewer operations, different operations, or differently arranged operations than those depicted in FIG. 7. Additionally, or alternatively, two or more of the operations of the flow 700 may be performed in parallel.

### Configurations and Exemplary Embodiments

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims. It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The construction and arrangement of the systems and methods as shown in the various exemplary embodiments are illustrative only. Although only a few embodiments have been described in detail in this disclosure, many modifications are possible (e.g., variations in port or destination quantity, data types, methods of reinsertion, reintroduction, etc., values of parameters, arrangements, etc.). For example, the position of elements may be reversed or otherwise varied, the connections between elements may be direct or indirect, such that there may be one or more intermediate elements connected in between, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions, and arrangement of the exemplary embodiments without departing from the scope of the present disclosure. For example, the embodiments of the present disclosure may be implemented by a single device and/or system or implemented by a combination of separate devices and/or systems.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

What is claimed is:

1. A method for generating media content consistent with a specific style and form, the method comprising:
generating, by one or more processors, a validated content data object by applying a filter to a content data object from a third party, wherein the validated content data object comprises content from the third party applicable to a content generation rule;
generating, by the one or more processors and based on the validated content data object, a prompt, wherein the prompt comprises the content from the third party, an instruction to generate a package of real-time content elements, and the content generation rule;
generating, by an LLM and based on the prompt, the package of real-time content elements comprising modified content of the content from the third party modified according to the content generation rule; and
communicating the package of real-time content elements to a display device.

2. The method of claim 1, further comprising:
generating, by the one or more processors, a user interface based on the package of real-time content elements, the user interface comprising a content editing area, wherein the content editing area displays the modified content and the user interface allows a user to make edits to the modified content;
generating an updated prompt based on the edits;
generating, by the LLM and based on the updated prompt, an updated package of real-time content elements; and
updating the user interface based on the updated package of real-time content elements.

3. The method of claim 2, further comprising:
generating, in the user interface, an interface element that indicates an attribute for the package of real-time content elements; and
receiving an updated attribute based on a user interaction with the interface element,
wherein generating the updated prompt is based on the updated attribute.

4. The method of claim 2, further comprising generating a second content generation rule based on the edits.

5. The method of claim 1, the prompt further comprising a formatting rule, wherein the formatting rule comprises at least one of:
a minimum word length;
a minimum character length;
a maximum word length; or
a maximum character length.

6. The method of claim 1, wherein generating the validated content data object comprises:
determining a portion of the content data object is applicable to the content generation rule;
applying a tag associated with the content generation rule to the portion of the content data object; and
generating the validated content data object based on the content data object and the tag.

7. The method of claim 6, wherein generating the validated content data object further comprises:
Generating style appropriateness scores by applying, to the content data object, an appropriateness filter related to an attribute of the content generation rule, the style appropriateness scores indicating a confidence level that respective portions of the content data object are suitable for application of the attribute; and
applying the tag to the respective portions of the content data object in response to a style appropriateness score of the style appropriateness scores being above a threshold.

8. The method of claim 7, wherein the attribute of the content generation rule comprises at least one of:
a humor attribute;
a solemnity attribute;
a gravitas attribute;
an empathy attribute;
an irony attribute;
a sarcasm attribute;
a sensationalism attribute;
a readability attribute;
a technicality attribute;
a jargon amount attribute;
a formality attribute;
an emotional tone attribute;
a regional attribute;
a demographic attribute;
a liberalness attribute;
a conservativeness attribute; or
a political voice attribute.

9. The method of claim 1, wherein the filter determines a portion of the content data object that comprises at least one of:
mature content;
violent content;
sensitive group content;
advertising content;
irrelevant content; or
malicious content.

10. The method of claim 1, wherein the package of real-time content elements comprises at least one of:
a headline;
a lower third chyron;
a web article;
a news ticker;
a social media post;
a blog post;
over-the-shoulder graphics;
full-screen graphics;
sub graphics;
transition scripts; or
anchor scripts.

11. The method of claim 1, wherein the content data object is received via a text feed.

12. A system for generating media content consistent with a specific style and form, the system comprising:
one or more memory devices having instructions stored thereon that, when executed by one or more processors, cause the one or more processors to perform operations comprising:
generating a validated content data object by applying a filter to a content data object from a third party, wherein the validated content data object comprises content from the third party applicable to a content generation rule;
generating, based on the validated content data object, a prompt, wherein the prompt comprises the content from the third party, an instruction to generate a package of real-time content elements, and the content generation rule;
obtaining, by communicating the prompt to an LLM, the package of real-time content elements comprising modified content of the content from the third party modified according to the content generation rule; and
communicating the package of real-time content elements to a display device.

13. The system of claim 12, the operations further comprising:
generating a user interface based on the package of real-time content elements, the user interface comprising:
a content editing area, wherein the content editing area displays the modified content and allows a user to make edits to the modified content; and
an interface element that indicates a tone for the package of real-time content elements;
generating an updated prompt based on the edits and an updated tone, wherein the updated tone is based on a user interaction with the interface element;
obtaining, by communicating the updated prompt to the LLM, an updated package of real-time content elements; and
updating the user interface based on the updated package of real-time content elements.

14. The system of claim 13, the operations further comprising generating a second content generation rule based on the edits.

15. The system of claim 12, the prompt further comprising a formatting rule, wherein the formatting rule comprises at least one of:
a minimum word length;
a minimum character length;
a maximum word length; or
a maximum character length.

16. The system of claim 15, wherein generating the validated content data object further comprises:
generating style appropriateness scores by applying, to the content data object, an appropriateness filter related to an attribute of the content generation rule, the style appropriateness scores indicating a confidence level that respective portions of the content data object are suitable for application of the attribute;
applying a tag to the respective portions of the content data object in response to a style appropriateness score the style appropriateness scores being above a threshold; and
generating the validated content data object based on the content data object and the tag.

17. The system of claim 12, wherein the filter determines a portion of the content data object that comprises at least one of:
mature content;
violent content;
sensitive group content;
advertising content;
irrelevant content; or
malicious content.

18. The system of claim 12, wherein the package of real-time content elements includes at least one of:
a headline;
a lower third chyron;
a web article;
a news ticker;
a social media post;
a blog post;
over-the-shoulder graphics;
full-screen graphics;
sub graphics;
transition scripts; or
anchor scripts.

19. The system of claim 12, wherein the content data object is received via a text feed.

20. A system for generating media content consistent with a specific style and form, the system comprising:
one or more memory devices having instructions stored thereon that, when executed by one or more processors, cause the one or more processors to perform operations comprising:
determining content from a third party that is suitable for application of a content generation rule;
generating, a prompt comprising the determined content from the third party, an instruction to generate a package of real-time content elements, and the content generation rule;
obtaining, by communicating the prompt to an LLM, the package of real-time content elements comprising modified content of the content from the third party modified according to the content generation rule;
generating a user interface based on the package of real-time content elements, the user interface comprising:
a content editing area, wherein the content editing area displays the modified content and allows a user to make edits to the modified content; and
an interface element that indicates a tone for the package of real-time content elements;
generating an updated prompt based on the edits and an updated tone, wherein the updated tone is based on a user interaction with the interface element; and
obtaining, by communicating the updated prompt to the LLM, an updated package of real-time content elements,
wherein the package of real-time content elements comprises at least one of:
a headline;
a lower third chyron;
a web article;
a news ticker;
a social media post;
a blog post;
over-the-shoulder graphics;
full-screen graphics;
sub graphics;
transition scripts; or
anchor scripts.
